(19) United States
(12) Patent Application Publication
(10) Pub. No.: US 2016/0276096 A1
(43) Pub. Date: Sep. 22, 2016

(54) POWER INDUCTOR

(71) Applicant: SAMSUNG ELECTRO-MECHANICS CO., LTD., Suwon-Si (KR)

(72) Inventors: Byeong Cheol MOON, Suwon-Si (KR); Il Jin PARK, Suwon-Si (KR)

(21) Appl. No.: 14/885,865

(22) Filed: Oct. 16, 2015

(30) Foreign Application Priority Data
Mar. 18, 2015 (KR) 10-2015-0037426

(51) Int. Cl. H01F 27/29; H01F 27/28

(52) U.S. Cl. CPC H01F 27/292; H01F 27/2804

(57) ABSTRACT

A power inductor may include: an insulating substrate; first and second coil layers disposed on both surfaces of the insulating substrate; an inductor body having a coil part including the insulating substrate and the first and second coil layers and a cover part including upper and lower cover parts, and having end portions of the first and second coil layers exposed to both end surfaces thereof; and first and second external electrodes electrically connected to the end portions of the first and second coil layers, respectively, wherein each of the upper and lower cover parts includes a metal composite plate. Therefore, the power inductor has excellent DC-bias characteristics.

### CROSS-REFERENCE TO RELATED APPLICATION

This application claims the benefit of priority to Korean Patent Application No. 10-2015-0037426 filed on Mar. 18, 2015, with the Korean Intellectual Property Office, the disclosure of which is incorporated herein by reference.

### BACKGROUND

The present disclosure relates to a power inductor.

In accordance with the recent development of portable devices such as smartphones, tablet PCs, and the like, a high-speed dual core or quad core application processor (AP) has been used, and a larger display area has been used, and thus a sufficient rated current may not be obtained with a ferrite inductor, according to the related art.

Therefore, recently, various metal composite inductors using metal powder having excellent DC-bias characteristics and an organic material have emerged.

Since, in a case of a metal material, an eddy current loss is significant under alternating current, it is difficult to use the metal material at a high frequency. However, the eddy current loss may be decreased by forming the metal material in a form of fine powder and insulating a surface of the metal powder to prepare a composite of the metal powder and an organic material, and recently, the metal material may be used at a frequency of 1 MHz or more.

However, as one disadvantage of insulation treatment as described above, since an insulation layer through which electricity does not flow inhibits a magnetic flux flow, it may be difficult to manufacture an inductor having high magnetic permeability.

In the metal composite inductor, a particle size may be selected to be suitable for a frequency required in order to decrease the eddy current loss of the metal powder.

Generally, in order to use the inductor at a high frequency, there is a need to increase specific resistance of a material and decrease a size of the material. Currently, metal powder having a size of about 20 μm to 30 μm has been used at 1 to 3 MHz or so.

Originally, magnetic permeability of a magnetic metal material may range from several thousands to several tens of thousands depending on the kind of material, but in a case of forming a composite, an insulating film may inhibit magnetic flux flow, and a demagnetizing field is generated by a non-magnetic space, and thus magnetic permeability is only about 20 to 25.

Therefore, inductance capable of being implemented in a small surface-mount device (SMD) type inductor may be restrictive.

Since magnetic permeability of the material has a significant correlation with a filling rate in the metal composite, a method of using a mixture of small powder having a size of 10 μm or less, which is significantly small, together with powder having a size of 20 μm to 30 μm or so to thereby fill empty spaces between large powder particles with the small powder has been used. Magnetic permeability may be increased up to 30 or more by this method.

However, in order to further increase magnetic permeability, a method of using third powder having a smaller size to fill the remaining spaces or a method of using powder having a larger size has been required. In the first method, there are problems in securing a material and the complexity of the process, and thus it is difficult to actually implement the first method. In the second method, magnetic permeability may be increased, but an eddy current loss may be increased. Further, there is a limitation in a maximum size of powder that may be used in a product process and structure.

In view of an eddy current loss of a material, there is no need to decrease sizes of all portions of the material, but a size of the material in a direction perpendicular to a magnetic flux direction is important. Therefore, even if the material is continuously disposed in the magnetic flux direction, in the case of manufacturing the material in a plate form having a sufficiently reduced thickness in the direction perpendicular to the magnetic flux direction, the eddy current loss may be decreased.

Therefore, the eddy current loss of the material may be decreased by forming this material to have a reduced thickness in the magnetic flux direction, and a winding inductor having a toroidal shape and using flakes has been suggested in the document.

However, in the flakes as described above, a metal filling rate in a composite may be decreased as compared to spherical powder. Therefore, magnetic permeability may be increased, but DC-bias characteristics may be significantly deteriorated. Therefore, inductance may be satisfied in a small inductor or high-inductance inductor, but DC-bias characteristics may be deteriorated, and thus uses thereof may be limited.

### SUMMARY

An examplary embodiment in the present disclosure may provide a power inductor capable of implementing a high saturation magnetic flux density to have excellent DC-bias characteristics while having high magnetic permeability by including a cover part including a metal composite plate.

According to an examplary embodiment in the present disclosure, a power inductor may include: an insulating substrate; first and second coil layers disposed on both surfaces of the insulating substrate; an inductor body having a coil part including the insulating substrate and the first and second coil layers and a cover part including upper and lower cover parts, and having end portions of the first and second coil layers exposed to both end surfaces thereof; and first and second external electrodes electrically connected to the end portions of the first and second coil layers, respectively, wherein each of the upper and lower cover parts may include a metal composite plate.

The insulating substrate may have a through hole in the center thereof, the metal composite plate may be a thin metal plate which is coated with an organic insulating film, and the upper and lower cover parts may include a plurality of metal composite plates stacked therein.

In addition, the coil part may include metal powder containing at least one of iron (Fe), an iron-nickel (Fe—Ni) alloy, an iron-silicon-aluminum (Fe—Si—Al) alloy, or an iron-silicon-chromium (Fe—Si—Cr) alloy. The metal composite plate may include an iron-nickel (Fe—Ni) based alloy, and the iron-nickel (Fe—Ni) based alloy may be permalloy.

The metal composite plate may have a thickness of 10 μm or less, and the metal composite plate may be formed by a plating method. Each of the upper and lower cover parts may be a plate shaped structure including the metal composite plate. The metal composite plates may be radially separated by the organic insulating films in relation to the center of the coil part.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a cross-sectional view of a power inductor according to an exemplary embodiment in the present disclosure;

FIG. 2 is a cross-sectional view of a magnetic flux flow of the power inductor according to an exemplary embodiment in the present disclosure;

FIG. 3A is a perspective view of a metal composite plate contained in a power inductor according to an exemplary embodiment in the present disclosure;

FIG. 3B is a perspective view of a metal composite plate contained in a power inductor according to another exemplary embodiment in the present disclosure; and

FIG. 4 is a plan view illustrating a shape of a cover part and a magnetic flux flow of the power inductor according to the exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

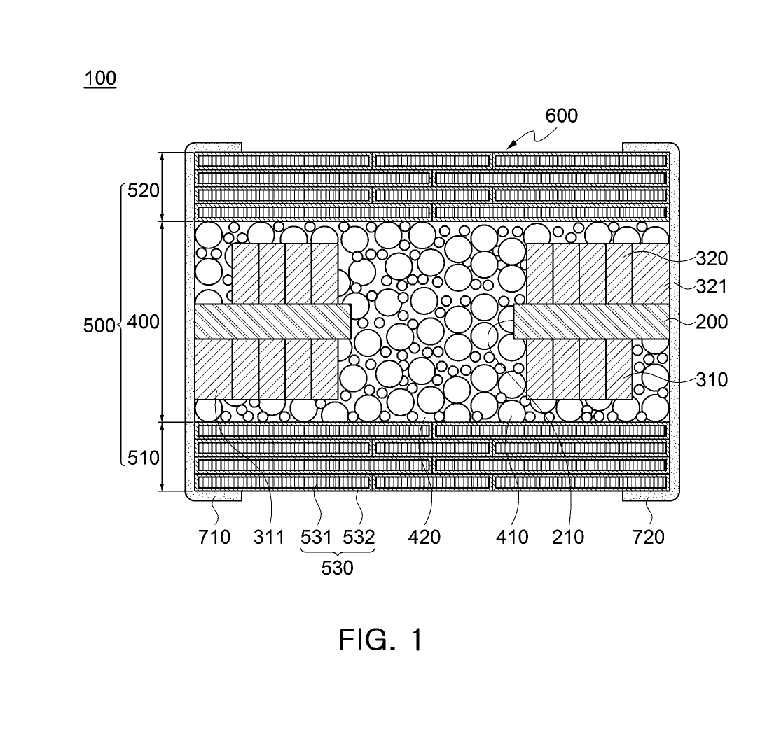

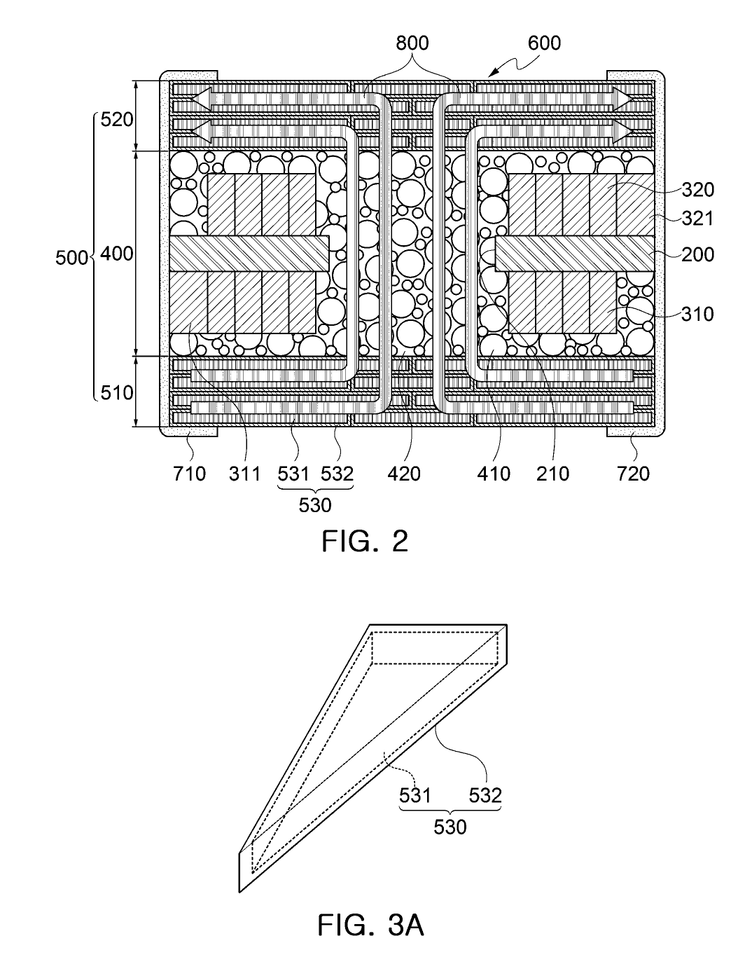

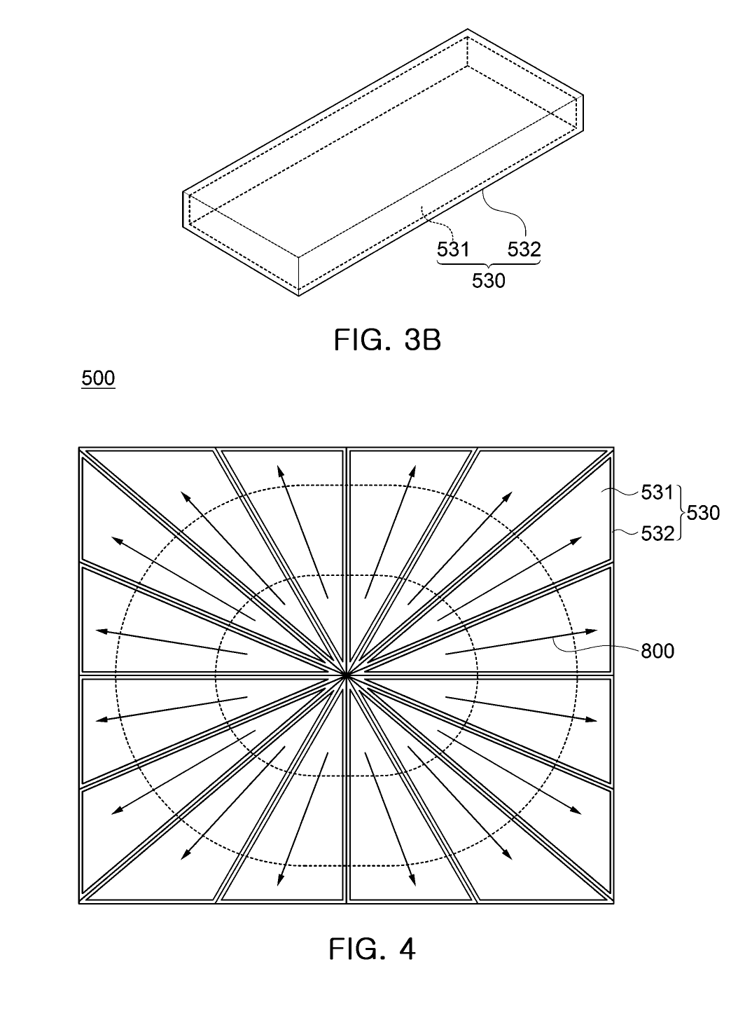

FIG. 1 is a cross-sectional view of a power inductor according to an exemplary embodiment, FIG. 2 is a cross-sectional view illustrating a magnetic flux flow of the power inductor according to the exemplary embodiment, FIG. 3A is a perspective view of a metal composite plate contained in a power inductor according to an exemplary embodiment, FIG. 3b is a perspective view of a metal composite plate contained in a power inductor according to another exemplary embodiment, and FIG. 4 is a plan view illustrating a shape of a cover part and a magnetic flux flow of the power inductor according to the exemplary embodiment.

Referring to FIGS. 1 through 4, a power inductor 100, according to an exemplary embodiment, may include an insulating substrate 200, first and second coil layers 310 and 320 formed on both surfaces of the insulating substrate 200, an inductor body 600 composed of a coil part 400 in which the insulating substrate 200 and the first and second coil layers 310 and 320 are included and a cover part 500 including upper and lower cover parts 520 and 510, and formed to respectively expose end portions 311 and 321 of the first and second coil layers 310 and 320 to end surfaces thereof, and first and second external electrodes 710 and 720 electrically connected to the end portions 311 and 321 of the first and second coil layers, respectively, wherein each of the upper and lower cover parts 520 and 510 includes a metal composite plate 530.

The insulating substrate 200 may be used as a support layer of the first and second coil layers 310 and 320 and may contain a magnetic material such as ferrite, or the like, or an insulation material such as a polymer resin 420, or the like.

Further, a through hole 210 having a circular, oval, or polygonal shape may be formed in the center of the insulating substrate 200, thereby assisting in the magnetic flux flow.

The magnetic flux flow 800 of the power inductor according to the exemplary embodiment will be described with reference to FIG. 2. As power is applied to a coil, a magnetic field is formed in directions of the arrows, and since the magnetic flux flow 800 is formed through the through hole 210, inhibition of the magnetic flux flow by the insulating substrate 200 may be significantly decreased.

The first and second coil layers 310 and 320 may be formed on both surfaces of the insulating substrate 200 using a conductive paste and may be electrically connected to each other through a via penetrating through the insulating substrate 200. In addition, both of the first and second coil layers 310 and 320 may be formed in a spiral shape.

The via may be formed by forming a through hole in the insulating substrate 200 using a laser method, a punching method, or the like, and filling the through hole with a conductive paste.

The first and second coil layers 310 and 320 may include metal powder 410 containing at least one of iron (Fe), an iron-nickel (Fe—Ni) alloy, an iron-silicon-aluminum (Fe—Si—Al) alloy, or an iron-silicon-chromium (Fe—Si—Cr) alloy, but the material of the first and second coil layers 310 and 320 is not limited thereto.

The coil part 400 in which the insulating substrate 200 and the first and second coil layers 310 and 320 are included may contain the metal powder 410 and the polymer resin 420, and the end portions of the first and second coil layers 310 and 320 may be externally exposed to thereby be electrically connected to external electrodes to be described below.

The first external electrode 710 may be electrically connected to the end portion 311 of the first coil layer, and the second external electrode 720 may be electrically connected to the end portion 321 of the second coil layer.

The first and second external electrodes 710 and 720 may be formed using a method of dipping the inductor body 600 in a conductive paste, a method of printing or depositing a conductive paste on both end surfaces of the inductor body 600, or the like.

Further, in order to impart conductivity to the first and second external electrodes 710 and 720, a metal such as gold (Au), silver (Ag), platinum (Pt), copper (Cu), nickel (Ni), palladium (Pd), or an alloy thereof may be used. If necessary, nickel plating layers (not illustrated) and tin plating layers (not illustrated) may be additionally formed.

The inductor body 600 may include the coil part 400 and the cover part 500, and the cover part 500 may include the upper and lower cover parts 520 and 510, wherein the upper cover part 520 may be formed on the coil part 400, and the lower cover part 510 may be formed below the coil part 400, thereby configuring the inductor body 600.

Each of the upper and lower cover parts 520 and 510 may contain the metal composite plate 530, wherein the metal composite plate 530 may be a thin metal plate 531 on which an organic insulating film 532 is coated.

The organic insulating film 532 may be formed of any material as long as the material can be coated on the thin metal plate 531 to electrically insulate the thin metal plate 531.

The thin metal plate 531 may be formed of an iron-nickel based alloy, wherein the iron-nickel based alloy may be permalloy, but is not limited thereto.

The metal composite plate 530 may have a thickness of 10 μm or less in order to decrease a magnitude of eddy current, but the thickness of the metal composite plate is not limited thereto.

The metal composite plate 530 may be formed by a bottom-up plating method. Alternatively, the metal composite plate 530 may be formed by a top-down method.

The upper and lower cover parts 520 and 510 may be formed by stacking a plurality of metal composite plates 530, and may be plate shaped structures including the plurality of metal composite plates 530.

In addition, the metal composite plates 530 may be radially separated by the organic insulating films 532 in relation to the center of the coil part.

In this case, the upper and lower cover parts 510 and 520 may include plate-shaped metal composite plates 530 having a triangular planar shape as illustrated in FIG. 3A.

When the cover part 500 is formed using the metal composite plates 530 as in the exemplary embodiment, a metal filling rate of the cover part 500 in which the magnetic flux flow 800 is formed by a magnetic field may be increased in such a manner that magnetic permeability may be increased, and thus, DC-bias characteristics may be improved.

Further, in a case in which the cover part 500 including the metal composite plates 530 radially separated by the organic insulating films 532 is formed as in the exemplary embodiment illustrated in FIG. 4 among the exemplary embodiments, since the metal composite plates 530 may be continuously disposed in the direction of the magnetic flux flow 800, a magnetic flux may smoothly flow, and since the cover part 500 is composed of the plurality of metal composite plates 530, an eddy current loss may be significantly decreased.

Furthermore, in a case in which the metal powder is used, it is difficult to control a shape and a filling rate of the metal powder, and thus an inductance variation of a power inductor may be increased. Conversely, in the power inductor according to the exemplary embodiment, since the cover part of the power inductor may be manufactured while controlling a size and a shape thereof with high precision using a plating method, a power inductor of which an inductance variation is decreased may be manufactured.

As set forth above, according to exemplary embodiments, since the cover part of the power inductor includes the metal composite plate to thereby have a high metal filling rate, the power inductor having excellent DC-bias characteristics may be provided.

Further, the body of the power inductor may be manufactured with high precision using the plating method, and thus the inductance variation of the power inductor may be decreased.

While exemplary embodiments have been shown and described above, it will be apparent to those skilled in the art that modifications and variations could be made without departing from the scope of the present invention as defined by the appended claims.

What is claimed is:

1. A power inductor comprising:
an insulating substrate;
first and second coil layers respectively disposed on end surfaces of the insulating substrate;
upper and lower cover parts; and
first and second external electrodes electrically connected to the end portions of the first and second coil layers, respectively,
wherein each of the upper and lower cover parts includes a metal composite plate.

2. The power inductor of claim 1, wherein the insulating substrate has a through hole in the center thereof.

3. The power inductor of claim 1, wherein the metal composite plate is a metal thin plate which is coated with an organic insulating film.

4. The power inductor of claim 1, wherein the upper and lower cover parts include a plurality of metal composite plates stacked therein.

5. The power inductor of claim 1, wherein the first and second coil layers include metal powder containing at least one of iron (Fe), an iron-nickel (Fe—Ni) alloy, an iron-silicon-aluminum (Fe—Si—Al) alloy, and an iron-silicon-chromium (Fe—Si—Cr) alloy.

6. The power inductor of claim 1, wherein the metal composite plate includes an iron-nickel (Fe—Ni) based alloy.

7. The power inductor of claim 6, wherein the iron-nickel (Fe—Ni) based alloy is permalloy.

8. The power inductor of claim 1, wherein the metal composite plate has a thickness of 10 μm or less.

9. The power inductor of claim 1, wherein the metal composite plate is formed by a plating method.

10. The power inductor of claim 1, wherein each of the upper and lower cover parts is a plate shaped structure including the metal composite plate.

11. The power inductor of claim 4, wherein the metal composite plates are radially separated by organic insulating films in relation to the center of the plurality of the metal composite parts.
